(19) United States
(12) Patent Application Publication
(10) Pub. No.: US 2025/0295272 A1
(43) Pub. Date: Sep. 25, 2025

(54) KITCHEN TOOL CONFIGURED FOR CONVENIENT HANDLING

(71) Applicant: Kayne Bachman, Spokane, WA (US)

(72) Inventor: Kayne Bachman, Spokane, WA (US)

(21) Appl. No.: 19/082,916

(22) Filed: Mar. 18, 2025

Related U.S. Application Data
(60) Provisional application No. 63/567,325, filed on Mar. 19, 2024.

(51) Int. Cl. A47J 43/28; F16B 47/00

(52) U.S. Cl. CPC A47J 43/288; F16B 47/00

(57) ABSTRACT

The present disclosure provides a kitchen tool which may be configured for convenient handling. Further, the kitchen tool may include a head which may be configured for performing a function. Further, the function may be associated with a culinary task. Further, the kitchen tool may include a handle comprising each of a first end and a second end. Further, the first end may be attached with the head. Further, the kitchen tool may include a suction cup which may be configured for securing the kitchen tool on a surface. Further, the second end may be attached with the suction cup. Further, the securing may be further based on a compression of the suction cup against the surface. Further, the compression reduces a pressure of a space under the suction cup to a suction pressure. Further, an atmospheric pressure of an environment pushes the kitchen tool against the surface.

### REFERENCE TO RELATED APPLICATIONS

This application claims the benefit of U.S. Provisional Patent Application No. 63/567,325, filed on Mar. 19, 2024, which is incorporated by reference herein in its entirety.

### FIELD OF DISCLOSURE

The present invention relates generally to utensils. More specifically, the present invention relates to a kitchen tools configured for convenient handling.

### BACKGROUND

The storage and maintenance of conventional kitchen tools, such as spatulas, includes a several operational challenges. Food residue on the working end of the spatula can come into contact with a surface and leads to cross-contamination. Further, an absence of designated resting mechanism requires a user to find an appropriate, clean surface to place the spatula during use. These challenges increase a complexity of culinary process, by reducing efficiency and cleanliness.

Therefore, there is a need for a kitchen tool configured for convenient handling, that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a kitchen tool which may be configured for convenient handling. Further, the kitchen tool may include a head which may be configured for performing a function. Further, the function may be associated with a culinary task. Further, the kitchen tool may include a handle comprising each of a first end and a second end. Further, the first end may be attached with the head. Further, the handle may be configured to be held by a user to perform the culinary task. Further, the kitchen tool may include a suction cup which may be configured for securing the kitchen tool on a surface. Further, the securing may be based on a force exerted on the kitchen tool against the surface. Further, the second end may be attached with the suction cup. Further, the securing may be further based on a compression of the suction cup against the surface. Further, the compression reduces a pressure of a space under the suction cup to a suction pressure. Further, the kitchen tool may be associated with an environment. Further, the environment may be associated with an atmospheric pressure. Further, the atmospheric pressure pushes the kitchen tool against the surface.

The present disclosure provides a kitchen tool which may be configured for convenient handling. Further, the kitchen tool may include a head which may be configured for performing a function. Further, the function may be associated with a culinary task. Further, the head includes one or more of a flat surface, a perforated surface and a wide surface. Further, the function includes one or more of a flipping a food item and a draining a liquid. Further, the food item may be associated with the liquid. Further, the kitchen tool may include a handle comprising each of a first end and a second end. Further, the first end may be attached with the head. Further, the handle may be configured to be held by a user to perform the culinary task. Further, the kitchen tool may include a suction cup which may be configured for securing the kitchen tool on a surface. Further, the securing may be based on a force exerted on the kitchen tool against the surface. Further, the second end may be attached with the suction cup. Further, the securing may be further based on a compression of the suction cup against the surface. Further, the compression reduces a pressure of a space under the suction cup to a suction pressure. Further, the kitchen tool may be associated with an environment. Further, the environment may be associated with an atmospheric pressure. Further, the atmospheric pressure pushes the kitchen tool against the surface.

The present disclosure provides a kitchen tool which may be configured for convenient handling. Further, the kitchen tool may include a head which may be configured for performing a function. Further, the function may be associated with a culinary task. Further, the head includes a curved surface which may be configured for holding a food item. Further, the kitchen tool may include a handle comprising each of a first end and a second end. Further, the first end may be attached with the head. Further, the handle may be configured to be held by a user to perform the culinary task. Further, the kitchen tool may include a suction cup which may be configured for securing the kitchen tool on a surface. Further, the securing may be based on a force exerted on the kitchen tool against the surface. Further, the second end may be attached with the suction cup. Further, the securing may be further based on a compression of the suction cup against the surface. Further, the compression reduces a pressure of a space under the suction cup to a suction pressure. Further, the kitchen tool may be associated with an environment. Further, the environment may be associated with an atmospheric pressure. Further, the atmospheric pressure pushes the kitchen tool against the surface.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a kitchen tool 100 configured for convenient handling, in accordance with some embodiments.

FIG. 2 is an illustration of a kitchen tool 100 secured against a surface 202, in accordance with some embodiments.

FIG. 3 is an illustration of a bottom view of a suction cup 106 of the kitchen tool 100 configured for convenient handling, in accordance with some embodiments.

FIG. 4 is an illustration of a kitchen tool 400 configured for convenient handling, in accordance with some embodiments.

FIG. 5 is an illustration of a kitchen tool 500 configured for convenient handling, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

### Overview

The present disclosure relates to a spatula turner with a suction cup on the end. Further, it relates to a kitchen utensil, comprising a suction cup, a handle, a body, and solid material such as silicone. In the preferred embodiment, the present invention is made of silicone, but other materials are additionally contemplated.

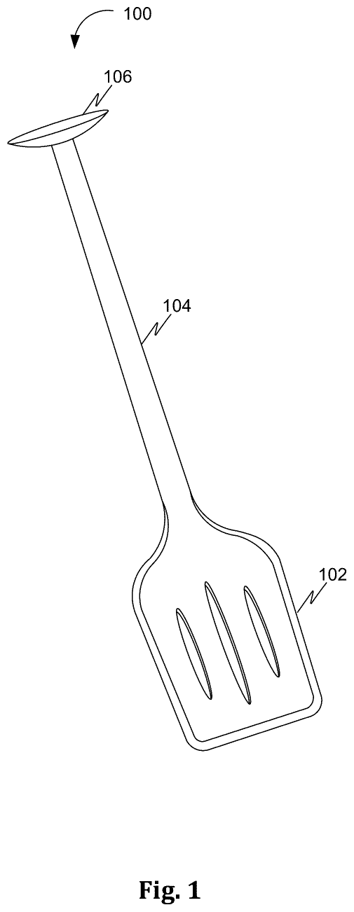

FIG. 1 is an illustration of a kitchen tool 100 configured for convenient handling, in accordance with some embodiments.

Accordingly, the kitchen tool 100 may include a head 102 which may be configured for performing a function. Further, the function may be associated with a culinary task. Further, the kitchen tool 100 may include a handle 104 comprising each of a first end and a second end. Further, the first end may be attached with the head 102. Further, the handle 104 may be configured to be held by a user to perform the culinary task. Further, the kitchen tool 100 may include a suction cup 106 which may be configured for securing the kitchen tool 100 on a surface 202. Further, the securing may be based on a force exerted on the kitchen tool 100 against the surface 202. Further, the second end may be attached with the suction cup 106. Further, the securing may be further based on a compression of the suction cup 106 against the surface. Further, the compression reduces a pressure of a space under the suction cup 106 to a suction pressure. Further, the kitchen tool 100 may be associated with an environment. Further, the environment may be associated with an atmospheric pressure. Further, the atmospheric pressure pushes the kitchen tool 100 against the surface.

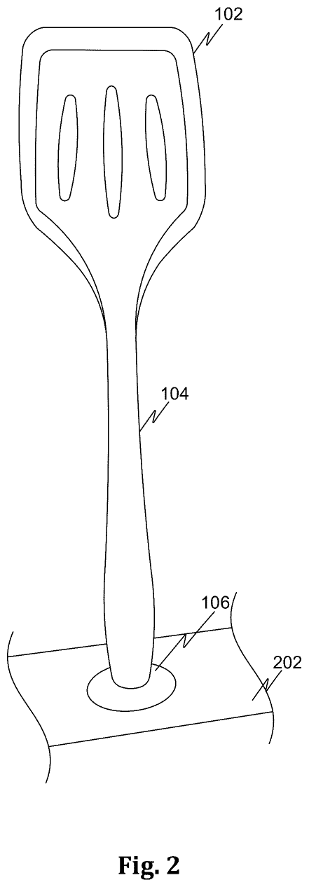

FIG. 2 is an illustration of a kitchen tool 100 secured against a surface 202, in accordance with some embodiments. Further, the surface 202 is oriented in a horizontal direction. Further, the kitchen tool 100 is configured to be in a vertical direction.

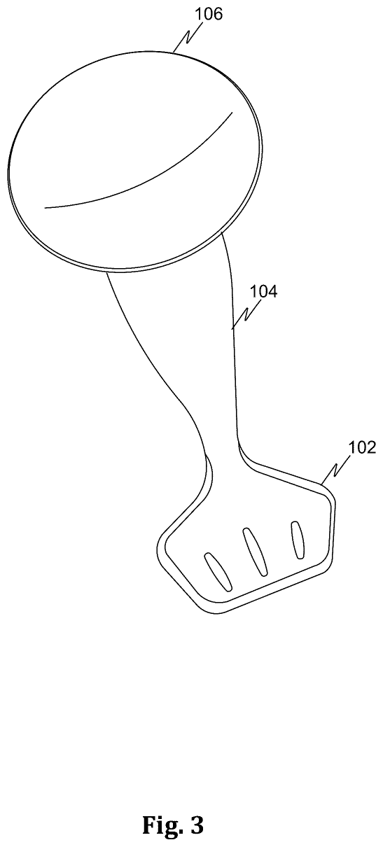

FIG. 3 is an illustration of a bottom view of a suction cup 106 of the kitchen tool 100 configured for convenient handling, in accordance with some embodiments. Further, the suction cup 106 is characterized by a concave shape.

In some embodiments, the suction cup 106 may be configured to trap an air in the space. Further, the compression reduces the pressure by pushing the air outward from the space to the environment.

In some embodiments, the suction cup 106 includes a material. Further, the material may be characterized by at least one a flexibility, an elasticity and a durability.

In some embodiments, the material may be further characterized by resistance to an environmental factor. Further, the environmental factor includes one or more of a temperature, a chemical, a heat, a light and a moisture.

In some embodiments, the head 102 may be characterized by a head characteristic. Further, the handle 104 may be characterized by a handle characteristic. Further, each of the head characteristic and the handle characteristic may be based on the culinary task.

In some embodiments, the head characteristic includes one or more of a head shape and a head dimension. Further, the handle characteristic includes one or more of a handle shape and a handle dimension.

In some embodiments, the function includes one or more of a flipping a food item and a draining a liquid. Further, the head 102 includes one or more of a flat surface, a perforated surface and a wide surface. Further, the handle dimension includes an elongated dimension. Further, the head shape includes one or more of a rectangular shape and a circle shape. Further, the food item may be associated with the liquid.

In some embodiments, each of the suction cup 106 and the surface includes a smooth surface. Further, each of the suction cup 106 and the surface may be characterized by an absence of pores.

In some embodiments, each of the head 102 and the suction cup 106 may be attached with the handle 104 based on one or more of a molding and a mechanical joining technique.

In some embodiments, the molding includes a process of shaping each of the head 102, the handle 104 and the suction cup 106 using a mold. Further, the kitchen tool 100 includes a seamless connection between one or more of the head 102, the handle 104 and the suction cup 106.

In some embodiments, the mechanical joining technique corresponds to a process of attaching each of the head 102 and the suction cup 106 with the handle 104 using a mechanical component.

In some embodiments, the material includes one or more of a silicone, rubber, a polyvinyl chloride, a polyurethane, a polyethylene, a polypropylene and an elastic polymer.

In some embodiments, the suction pressure may be characterized by a first pressure value. Further, the atmospheric pressure may be characterized by a second pressure value. Further, the first pressure value may be smaller than the second pressure value.

In some embodiments, the securing may be further based on a pressure difference between the first pressure value and the second pressure value.

In some embodiments, the pressure difference creates an adhesive force between the suction cup 106 and the surface 202. Further, the adhesive force facilitates the securing.

In some embodiments, the function includes a collecting a food item. Further, the head 102 includes a curved surface which may be configured for holding the food item.

In some embodiments, the head 102 includes one or more of a meshed curved surface, a meshed flat surface and a meshed basket. Further, each of the meshed curved surface, the meshed plate and the meshed basket includes a mesh. Further, the function includes an exposing a food item to a thermal exchange environment. Further, the thermal exchange environment facilitates one or more of a heating of the food item and a cooling of the food item.

In some embodiments, the head 102 includes two or more prongs. Further, the function includes one or more of a flipping, a picking and a mixing.

Accordingly, the kitchen tool 100 may include a head 102 which may be configured for performing a function. Further, the function may be associated with a culinary task. Further, the head 102 includes one or more of a flat surface, a perforated surface and a wide surface. Further, the function includes one or more of a flipping a food item and a draining a liquid. Further, the food item may be associated with the liquid. Further, the kitchen tool 100 may include a handle 104 comprising each of a first end and a second end. Further, the first end may be attached with the head 102. Further, the handle 104 may be configured to be held by a user to perform the culinary task. Further, the kitchen tool 100 may include a suction cup 106 which may be configured for securing the kitchen tool 100 on a surface. Further, the securing may be based on a force exerted on the kitchen tool 100 against the surface. Further, the second end may be attached with the suction cup 106. Further, the securing may be further based on a compression of the suction cup 106 against the surface. Further, the compression reduces a pressure of a space under the suction cup 106 to a suction pressure. Further, the kitchen tool 100 may be associated with an environment. Further, the environment may be associated with an atmospheric pressure. Further, the atmospheric pressure pushes the kitchen tool 100 against the surface.

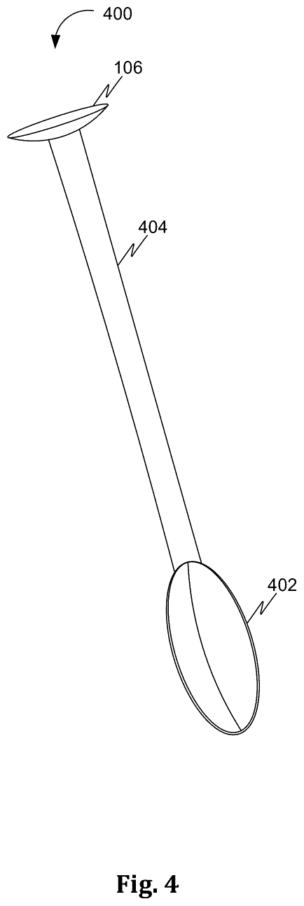

FIG. 4 is an illustration of a kitchen tool 400 configured for convenient handling, in accordance with some embodiments.

Accordingly, the kitchen tool 400 may include a head 402 which may be configured for performing a function. Further, the function may be associated with a culinary task. Further, the head 402 includes a curved surface which may be configured for holding a food item. Further, the kitchen tool 400 may include a handle 404 comprising each of a first end and a second end. Further, the first end may be attached with the head 402. Further, the handle 404 may be configured to be held by a user to perform the culinary task. Further, the kitchen tool 400 may include a suction cup 106 which may be configured for securing the kitchen tool 400 on a surface. Further, the securing may be based on a force exerted on the kitchen tool 400 against the surface. Further, the second end may be attached with the suction cup 106. Further, the securing may be further based on a compression of the suction cup 106 against the surface. Further, the compression reduces a pressure of a space under the suction cup 106 to a suction pressure. Further, the kitchen tool 400 may be associated with an environment. Further, the environment may be associated with an atmospheric pressure. Further, the atmospheric pressure pushes the kitchen tool 400 against the surface.

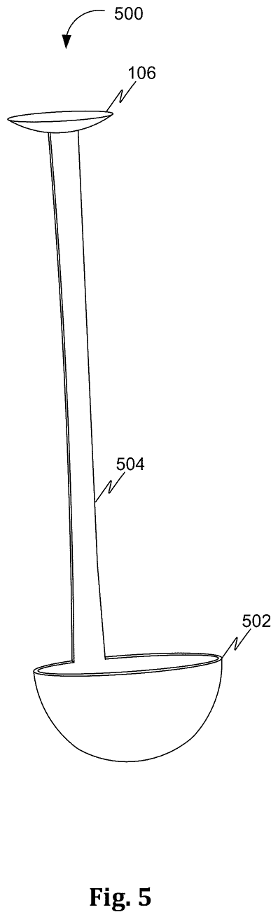

FIG. 5 is an illustration of a kitchen tool 500 configured for convenient handling, in accordance with some embodiments. Further, the kitchen tool 500 comprises each of a head 502, a handle 504 and the suction cup 106. Further, the head 502 comprises a deep curved surface configured for holding a food item.

In some embodiments, the culinary task corresponds one or more of a food preparation activity and a food serving activity.

In some embodiments, the material may be further characterized by a heat resistance property.

In some embodiments, the surface may be oriented in a horizontal direction. Further, the kitchen tool 100 may be configured to be in vertical direction.

In some embodiments, the surface may be oriented in a vertical direction. Further, the kitchen tool 100 may be configured to be in horizontal direction.

In some embodiments, the suction cup 106 may be characterized by a concave shape.

In some embodiments, the kitchen tool 100 includes one or more of a spatula, a spoon and a ladle.

In some embodiments, the suction pressure includes a vacuum pressure.

In some embodiments, the vacuum pressure ranges from hundred Pascal to thousand Pascal.

In some embodiments, the function includes one or more of a chopping, a slicing and a dicing. Further, the head 102 includes a blade.

In some embodiments, the blade includes a stainless steel material. Further, the handle includes one or more of a wood material, a plastic material, a metal material and a rubber material.

In some embodiments, the blade may be characterized by a blade dimension. Further, the blade dimension may be based on the culinary task.

In some embodiments, the head 102 further includes one or more of a straight edge and a tapered edge.

In some embodiments, the head 102 includes one or more of a wood material, a metal material and a silicone material. Further, the handle 104 includes a heat resistance material.

In some embodiments, the elongated dimension facilitates a secure interaction with one or more of the food item and the liquid.

In some embodiments, the function includes one or more of a scraping a food item and a folding a food item. Further, the head 102 includes one or more of a rounded edge and a narrow tip.

In some embodiments, the head 102 includes one or more of a flexible material and a heat resistant material.

In some embodiments, the food item includes a liquid. Further, the head 102 may be further configured for pouring the liquid. Further, the head 102 includes a tapered edge. Further, the tapered edge controls a flow of the liquid.

In some embodiments, the curved surface 902 includes one or more of a deep curved surface and a shallow curved surface.

In some embodiments, the thermal exchange environment associated with one or more of a heating object and a cooling object.

In some embodiments, the heating object includes one or more of a flame, an oil and a hot plate. Further, the cooling object includes one or more of a water and an ice cube.

In some embodiments, the head 102 includes at least one a metal, a plastic material and a wood material.

In some embodiments, the mesh may be configured for draining a liquid from the food item. Further, the food item may be associated with the liquid.

In some embodiments, a kitchen tool 100 characteristic may be based on a mold characteristic. Further, the kitchen tool 100 and the mold may be characterized by the kitchen tool 100 characteristic and the mold characterized respectively.

In some embodiments, each of the kitchen characteristic and the mold characteristic includes at least one a shape and a surface smoothness.

In some embodiments, the mechanical component includes one or more of a screw and a rivet.

In some embodiments, the head 102 includes two or more wires. Further, the two or more wires includes a looped wire. Further, the function includes stirring.

In some embodiments, the head 102 includes a two or more tips. Further, the head 102 may be configured to grasp an object by reducing a distance between the two or more tips. Further, the object includes the food item.

In some embodiments, the head 102 includes two or more pores 2502. Further, the two or more pores includes a sharp edge. Further, the function includes a grating.

In some embodiments, the function includes one or more of measuring a food item and peeling a food item.

In some embodiments, the head 102 includes a two or more bristles. Further, the function includes applying a first food item on a second food item. Further, the culinary task may be based on each of the first food item and the second food item.

Although the invention has been explained in relation to its preferred embodiment, it is to be understood that many other possible modifications and variations can be made without departing from the spirit and scope of the invention as hereinafter claimed.

1. A kitchen tool configured for convenient handling, the kitchen tool comprising:
a head configured for performing a function, wherein the function is associated with a culinary task;
a handle comprising each of a first end and a second end, wherein the first end is attached with the head, wherein the handle is configured to be held by a user to perform the culinary task; and
a suction cup configured for securing the kitchen tool on a surface, wherein the securing is based on a force exerted on the kitchen tool against the surface, wherein the second end is attached with the suction cup, wherein the securing is further based on a compression of the suction cup against the surface, wherein the compression reduces a pressure of a space under the suction cup to a suction pressure, wherein the kitchen tool is associated with an environment, wherein the environment is associated with an atmospheric pressure, wherein the atmospheric pressure pushes the kitchen tool against the surface.

2. The kitchen tool of claim 1, wherein the suction cup is configured to trap an air in the space, wherein the compression reduces the pressure by pushing the air outward from the space to the environment.

3. The kitchen tool of claim 1, wherein the suction cup comprises a material, wherein the material is characterized by at least one a flexibility, an elasticity and a durability.

4. The kitchen tool of claim 3, wherein the material is further characterized by resistance to an environmental factor, wherein the environmental factor comprises at least one of a temperature, a chemical, a heat, a light and a moisture.

5. The kitchen tool of claim 1, wherein the head is characterized by a head characteristic, wherein the handle is characterized by a handle characteristic, wherein each of the head characteristic and the handle characteristic is based on the culinary task.

6. The kitchen tool of claim 5, wherein the head characteristic comprises at least one of a head shape and a head dimension, wherein the handle characteristic comprises at least one of a handle shape and a handle dimension.

7. The kitchen tool of claim 6, wherein the function comprises at least one of a flipping a food item and a draining a liquid, wherein the head comprises at least one of a flat surface, a perforated surface and a wide surface, wherein the handle dimension comprises an elongated dimension, wherein the head shape comprises at least one of a rectangular shape and a circle shape, wherein the food item is associated with the liquid.

8. The kitchen tool of claim 1, wherein each of the suction cup and the surface comprises a smooth surface, wherein each of the suction cup and the surface is characterized by an absence of pores.

9. The kitchen tool of claim 1, wherein each of the head and the suction cup is attached with the handle based on at least one of a molding and a mechanical joining technique.

10. The kitchen tool of claim 9, wherein the molding comprises a process of shaping each of the head, the handle and the suction cup using a mold, wherein the kitchen tool comprises a seamless connection between at least one of the head, the handle and the suction cup.

11. The kitchen tool of claim 9, wherein the mechanical joining technique corresponds to a process of attaching each of the head and the suction cup with the handle using a mechanical component.

12. The kitchen tool of claim 3, wherein the material comprises at least one of a silicone, rubber, a polyvinyl chloride, a polyurethane, a polyethylene, a polypropylene and an elastic polymer.

13. The kitchen tool of claim 1, wherein the suction pressure is characterized by a first pressure value, wherein the atmospheric pressure is characterized by a second pressure value, wherein the first pressure value is smaller than the second pressure value.

14. The kitchen tool of claim 13, wherein the securing is further based on a pressure difference between the first pressure value and the second pressure value.

15. The kitchen tool of claim 14, wherein the pressure difference creates an adhesive force between the suction cup and the surface, wherein the adhesive force facilitates the securing.

16. The kitchen tool of claim 1, wherein the function comprises a collecting a food item, wherein the head comprises a curved surface configured for holding the food item.

17. The kitchen tool of claim 1, wherein the head comprises at least one of a meshed curved surface, a meshed flat surface and a meshed basket, wherein each of the meshed curved surface, the meshed plate and the meshed basket comprises a mesh, wherein the function comprises an exposing a food item to a thermal exchange environment, wherein the thermal exchange environment facilitates at least one of a heating of the food item and a cooling of the food item.

18. The kitchen tool of claim 1, wherein the head comprises a plurality of prongs, wherein the function comprises at least one of a flipping, a picking and a mixing.

19. A kitchen tool configured for convenient handling, the kitchen tool comprising:
a head configured for performing a function, wherein the function is associated with a culinary task, wherein the head comprises at least one of a flat surface, a perforated surface and a wide surface, wherein the function comprises at least one of a flipping a food item and a draining a liquid, wherein the food item is associated with the liquid.
a handle comprising each of a first end and a second end, wherein the first end is attached with the head, wherein the handle is configured to be held by a user to perform the culinary task; and
a suction cup configured for securing the kitchen tool on a surface, wherein the securing is based on a force exerted on the kitchen tool against the surface, wherein the second end is attached with the suction cup, wherein the securing is further based on a compression of the suction cup against the surface, wherein the compression reduces a pressure of a space under the suction cup to a suction pressure, wherein the kitchen tool is associated with an environment, wherein the environment is associated with an atmospheric pressure, wherein the atmospheric pressure pushes the kitchen tool against the surface.

20. A kitchen tool configured for convenient handling, the kitchen tool comprising:
a head configured for performing a function, wherein the function is associated with a culinary task, wherein the head comprises a curved surface configured for holding a food item;
a handle comprising each of a first end and a second end, wherein the first end is attached with the head, wherein the handle is configured to be held by a user to perform the culinary task; and
a suction cup configured for securing the kitchen tool on a surface, wherein the securing is based on a force exerted on the kitchen tool against the surface, wherein the second end is attached with the suction cup, wherein the securing is further based on a compression of the suction cup against the surface, wherein the compression reduces a pressure of a space under the suction cup to a suction pressure, wherein the kitchen tool is associated with an environment, wherein the environment is associated with an atmospheric pressure, wherein the atmospheric pressure pushes the kitchen tool against the surface.
